(19) United States
(12) Patent Application Publication
(10) Pub. No.: US 2010/0178956 A1
(43) Pub. Date: Jul. 15, 2010

(54) Method and apparatus for mobile voice recognition training

(76) Inventor: Rami B. Safadi, Vienna, VA (US)

Correspondence Address: Intrinsic Law Corp., 235 Bear Hill Road, Suite 301, Waltham, MA, 02451, US

(21) Appl. No.: 12/657,149

(22) Filed: Jan. 14, 2010

Related U.S. Application Data
(60) Provisional application No. 61/144,550, filed on Jan. 14, 2009.

(51) Int. Cl. H04M 1/00; G10L 15/06; H04N 7/18

(52) U.S. Cl. 455/563; 704/243; 348/77; 348/E07.085

(57) ABSTRACT

A system and method for training an automatic speech recognition system to improve user-dependent and/or user-independent performance of the system. In some embodiments, a user of a mobile device is audibly prompted to respond with an audible response utterance or sequence that is then used to improve the effectiveness of the voice recognition system.

### RELATED APPLICATIONS

This application incorporates by reference and claims the priority and benefit of U.S. Provisional Patent Application Ser. No. 61/144,550, under 35 U.S.C. Sec. 119(e), having the same title, which was filed on Jan. 14, 2009.

### TECHNICAL FIELD

The present disclosure generally relates to the training of voice recognition or automatic speech recognition (ASR) systems such as those used to convert speech to text or speech in a first language or dialect to another. More specifically, the present disclosure is directed to the use of mobile devices to enable training for user-dependent and user-independent recognition capabilities in speech recognition systems.

### BACKGROUND

Present systems provide voice recognition capability, or speech recognition capability, which generally comprise software and associated hardware for detecting human utterances and delivering an output corresponding to said utterances. Specifically, voice recognition has been used to take a spoken input and provide a corresponding written or translated output thereof.

Typical voice recognition systems include a computer, such as a desktop PC or workstation. The computer is coupled to an input apparatus such as a microphone, which is in turn coupled to an analog-to-digital (D/A) converter, card, or circuit board, to convert analog signals from the microphone to digital signals that can be processed and stored by the computer and software running on the computer. Also, typical voice recognition systems include software and associated hardware for processing the digitized detected voice signals into elements that can be matched with known parameters to determine the meaning or identity of the utterances. Therefore, the voice recognition systems can provide a suitable output such as written (printed) words, which can be placed into a document, stored, transmitted, translated, or otherwise processed by the system.

One challenge in voice recognition is that the human speakers providing the spoken utterances tend to deliver the utterances in unique ways as opposed to an exactly deterministic delivery that a machine is adapted to easily accept. That is, variation in spoken utterances from one speaker to another exist, which complicate the recognition part of the voice recognition process. These variations can arise from the speakers coming from different nationalities and having varying accents, variations in speaking style from one speaker to another among the same nationality, or variations in delivery of the same utterances by the same speaker from one instance to the next.

Accordingly, voice recognition systems have been provided with ways to account for and accommodate such variations in delivery of utterances. For example, databases containing many versions of an utterance, or averaged or aggregated versions of the utterances have been developed. The databases can provide look-up information to assist in the recognition of the input utterances. The quality and depth of the information used to develop the databases, as well as some information about the conditions and nature of the speaker can be useful to further refine the outcome of the voice recognition process. The better the database and algorithms and input information is, the fewer errors would result from the voice recognition, and the more precise the output.

To develop such voice recognition support databases, a learning system is sometimes used to accumulate or learn key utterances and phrases. In some examples, a user of a voice recognition system is prompted upon initial installation of the system to speak a predetermined known set of utterances into a microphone, which are used by the system to develop an understanding of the phonetic and other details of that individual speaker's speech. Thereafter, the system relies on this learned information to adapt to the user's subsequent usage of the system. Also, speech recognition systems can be pre-programmed with a vocabulary of average or typical information collected by the maker of the system before shipping to the end user. This information can be used as a starting point, which may later be refined as mentioned above by a training or learning process to accommodate the individual end user. Sometimes this average or typical speech database and associated speech recognition parameters are referred to as speaker-independent or user-independent because it is a best guess approach that is optimized for an arbitrary speaker as opposed to a specific speaker. This serves as the default database for speech recognition systems, which could be used with some effectiveness as is with any speaker, or could be further refined as described above to be speaker-dependent.

Speech recognition systems continue to suffer from inefficiencies and inaccuracies, especially in recognizing and processing utterances from one user to another and due to the deficiencies of the default speaker-independent databases. Better learning or training processes are desired to improve the performance of the speech recognition systems, including for speaker-dependent or user-dependent voice recognition. Also, there is a need to acquire good and numerous examples of spoken utterances to develop a better default or speaker-independent database for voice recognition systems.

### SUMMARY

Embodiments hereof include systems and methods for speech recognition. These include those with some or all elements implemented on a mobile device, for example a device such as a mobile telephone, personal digital assistant (PDA), or other personal electronic portable apparatus. The apparatus can include the hardware on which speech recognition software is run and storage means for holding information collected and used in the speech recognition process. Methods for using and training the system for optimal performance are also provided. In some embodiments, a plurality of mobile phones, each providing utterances from its users, can be used to develop a speaker-independent speech recognition database. In other embodiments, software executing on a mobile device is used to prompt the device's user to speak predetermined utterances into the device to develop a user-specific speech recognition capability, and/or add to an existing user-independent speech recognition database. This can provide advantages over traditional learning or training methods. Additionally, the present system is appropriate for use with persons having visual handicaps that do not permit them to read the prompts from traditional speech recognition training interfaces.

### BRIEF DESCRIPTION OF THE DRAWINGS

For a fuller understanding of the nature and advantages of the present invention, reference is be made to the following detailed description of preferred embodiments and in connection with the accompanying drawings, in which:

FIG. 1 illustrates an exemplary method for training a voice recognition system;

FIG. 2 illustrates an exemplary trainable voice recognition system using mobile devices; and

FIG. 3 illustrates an exemplary mobile device according to some embodiments.

### DETAILED DESCRIPTION

Many people routinely carry around mobile personal electronic communication devices such as cellular phones or multi-functional products sometimes referred to as smart phones and the like. Several types of mobile communication devices include features for communicating written (printed, typed) information that is entered by a user into a keypad. The keypad can comprise a set of buttons that are pressure-sensitive or touch-sensitive, a surface responsive to a special stylus, a touch screen with programmed soft buttons, etc. The result of the user's typing or inscription is recognized by the apparatus and delivered to its intended destination, for example as a memo, a text message, or electronic mail (email) message and the like. It is useful to enable the apparatus to recognize spoken utterances, thereby eliminating or augmenting or reducing the need to look at the keypad and enter information manually into the device, and to permit a reduction of the accompanying distraction required to manually scribe or type into the apparatus. Also, the speed with which a user can enter information into the apparatus is increased if the user can speak into the device as opposed to type or write into it. Additionally, especially when attending to other tasks or in a situation that requires the user's attention in traffic, it is preferable for the user to be able to give spoken input rather than typed or written input into the device. Hence voice recognition or automatic speech recognition (ASR) is one alternative to requiring typed input to a mobile device.

As mentioned above, the performance of the speech recognition apparatus and application benefits from learning or training that then accommodates the individual speaker's speech pattern. Also, developers of speech recognition systems wish to collect a large variety of examples of speech to develop more effective user-independent databases and software. The traditional way of collecting the predetermined training utterances involves the user reading from a computer display screen or similar page of printed material. This is not possible for people with visual disabilities, and is not safe or convenient for people using handheld mobile devices with small display screens.

Accordingly, the present system and method include apparatus and ways for training speech recognition systems by presenting the users with non-visual prompts, for example audible prompts, as a way to collect a set of pre-determined utterances for use in training the system. Also, other embodiments allow for unattended or semi-automated collections of utterances from users, which can be analyzed or recorded or collected for improving the performance of the system.

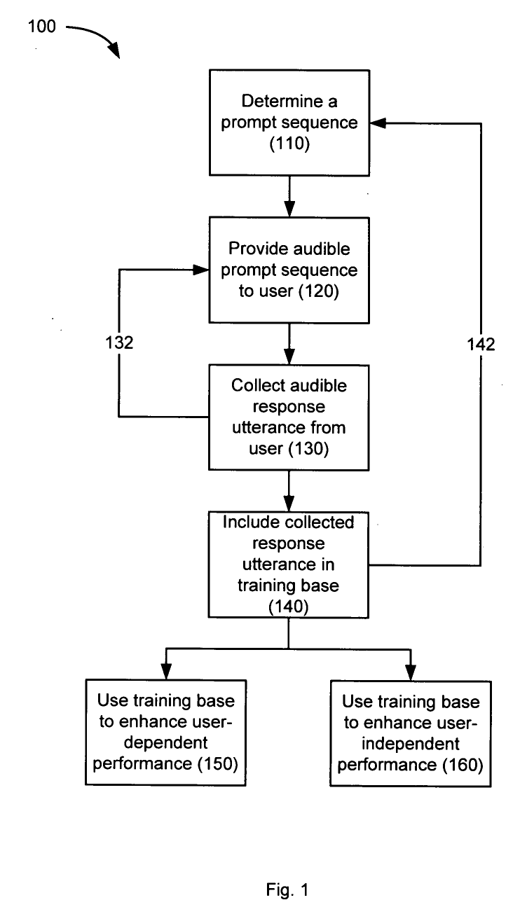

We now refer to FIG. 1, which illustrates a general method 100 for training a speech recognition system according to one or more embodiments hereof. At step 110 the system determines a prompt sequence with which to prompt a user. The prompt sequence can be a brief phrase, sentence, or a word, or another sequence that is deemed useful for developing the performance of the voice recognition system. For example, the audible prompt sequence may be one or more speech synthesized utterances or pre-recorded phrases or words that can be played back to the user through the mobile device's speaker or headset. The audible prompt sequence may be generated in real time by the mobile device or may be converted from stored file data or may be retrieved from a remote source e.g., from a server or database coupled to the mobile device by a network.

At step 120 the audible prompt sequence is delivered to the user in an audible format as mentioned above by converting the appropriate source of the prompt to an audible signal. For example, the prompt sequence of utterances is delivered over a speaker of the user's mobile device such as a loud speaker, an earphone, Bluetooth® wireless ear piece, or the like. A visual output on the mobile device may also be included in this step, but various embodiments do not require this, and an audio-only prompt sequence or phrase may be used.

At step 130 the system collects an audible response utterance or sequence of utterances from the user. The user can respond thus to the audible prompt sequence with one or more audible response utterances spoken into the mobile device's microphone, or into a hands-free microphone or other sound-sensitive apparatus. The process of prompting (120) and collecting user utterances (130) can be repeated as shown at 132 arbitrarily to train the system. In some embodiments, but not necessarily all, other input from the user may be collected in the mobile device so as to assist in determining the words of the user. For example, a camera within the mobile device (digital still cam or video camera) can be used to analyze the face, mouth, lips, or other body parts of the user so as to further quantify or recognize the user's intentions and speech. That is, in some embodiment, only the user's voice is used as a source of an audible response. In other embodiments both the user's audible response (utterances) as well as the user's face and/or mouth gestures are used to help recognize the user's response and learn the same.

Once collected at steps 130, 132, the utterances of a user can be applied to a learning or training database at step 140. These can reside fully or partially on the mobile device and/or a portion of the system coupled to the mobile device, for example on a server as will be described below. The inclusion of information collected from the user at the mobile device 140 can be followed by repeated further determination of more prompt sequences 110 to be requested of the user as shown by loop 142. Databases of the user audible responses can be formed or augmented. And in the cases where visual cues are also collected from the user of the mobile device, databases for the facial and/or mouth visual input cues can also be made and used for improving the speech recognition system.

The resulting collection and processing of the utterances or cues from the above training process is then used to improve the performance of the voice recognition system by customizing the system's response to the individual user providing the utterances to develop the system's user-dependent performance at 150. This as well as or alternatively can be used to improve the system's use-independent recognition performance by including the newly collected utterance information in the user-independent database of the system.

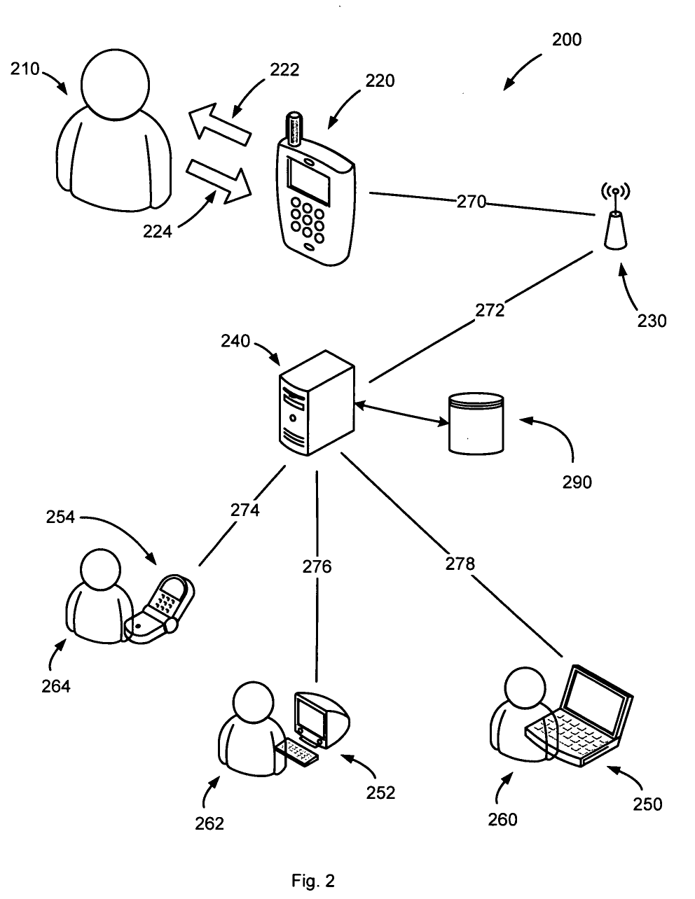

FIG. 2 illustrates a trainable voice recognition system 200. The system includes or operates in conjunction with a mobile device 220 such as a cellular telephone with an applications processor capable of executing voice recognition instructions and software or firmware. The mobile device 220 provides at least an audible prompt message, signal, or sequence 222 to a user 210. The user 210 responds to the prompt 222 with at least an audible response 224 corresponding to prompt 222. The prompt 222 and the response 224 are at least audible in nature, but can further include visual cues or images in some embodiments. For example, the system prompts the user with an audible “Repeat after me:” sound or tone, followed by a playback or a pre-recorded or downloaded or machine synthesized prompt sequence 222. The user 210 hears the prompt then speaks the response utterances he or she was asked to repeat. Exemplary prompts can include “What is your name?:” or “Where do you live?:” or other prompts designed to collect information and responses that improve the performance of the user-dependent and/or user-dependent voice recognition system.

Once the user's response 224 is collected at mobile device 220, the response 224, or a signal corresponding thereto, is delivered over a suitable network 270 to a collection point 230. In some embodiments, the mobile device 220 and/or the mobile device in cooperation with a coupled server or other machine may convert the audible sound from the user response 224 into one or more digitized files, packets, or signals. In some embodiments the network 270 comprises a wireless or cellular network in communication with the mobile device 220, and the collection point 230 comprises a cellular base station.

In some embodiments, the collected user responses are then directed to a portion of the system, for example a server 240, by way of a network 272 coupling collection point 230 and server 240. Server 240 may include or be coupled to a local or remote database 290 or other portions of the system 200. Additional hardware, software or firmware may reside on server 240 to accomplish processing of the collected user responses and to generate the prompt sequence determinations mentioned earlier.

The system 200, including or in conjunction with server 240, then uses the collected information, along with any other suitable information initially available to it to improve the performance of voice recognition features of the system. For example, other users 260, 262, 264 connected to the system may derive user-independent voice recognition improvements facilitated by collection of prompt and response data from user 210. In some embodiments, each of users 210, 260, 262, and 264 benefit from the use and training of the system 200 by each of the other users collectively and/or individually.

Some of the users, e.g., user 264 are coupled to the system 200 by way of wireless or cellular network 274 and use the features of the system 200 on mobile devices 254. Other users, e.g., users 262 and 260, are coupled to the system 200 by way of telephone, landline, or hard wire Internet style data and/or voice networks to computing devices 252 and 250 respectively.

It should be appreciated that the variety of mobile devices available today and in the future can provide substantial benefits to the present system and method. For example, regional variations and utilization of input from a large number of speakers can increase the number of sample speakers used to train the voice recognition system.

It should also be appreciated that the present systems and methods allow for user-dependent voice recognition training that can be implemented on a user's individual electronic product, e.g., a mobile phone. The user-dependent performance improvements can take place in the user's mobile device 220 using software on the user's mobile device 220. However, in addition, the results collected from the individual user may also be transmitted to a portion of the system to be used in improving the system's user-independent voice recognition performance.

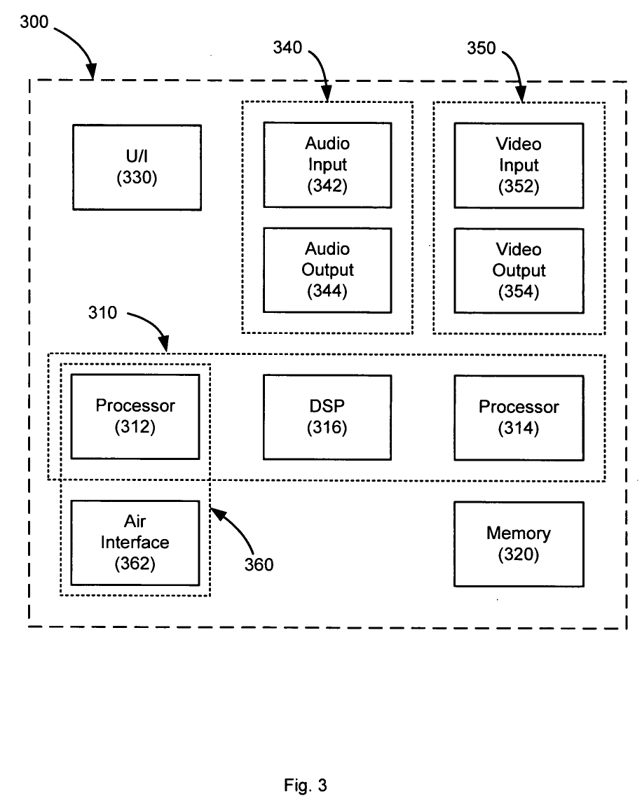

FIG. 3 illustrates an exemplary representation of a mobile communication device 300 adapted to provide automatic speech recognition capability to its user. The device 300 includes a processing sub-system 310 that can execute computer-readable instructions in an electronic medium to cause device 300 to perform certain functions. Device 300 also includes one or more memory devices 320 for storing information, data, or instructions.

Device 300 is equipped with one or more user interface (U/I) instrumentalities or modules 330 for allowing a user or another machine to interact with device 300. The U/I 330 may include keys, buttons, touch screens, knobs, track balls, keyboards, or other user input/output apparatus. Some or all of the components of mobile device 300 may be implemented in circuitry constructed on a suitable circuit board such as is known to those familiar with the art of designing personal mobile communication devices. Also, some of the components of device 300 may be constructed on one or more integrated circuits (ICs) or semiconducting chip products, including standard components or application specific integrated circuits (ASICs). Buses may be employed to interconnect the various elements of device 300 and pass data, signals, or communications among the various elements of device 300.

Device 300 also includes an audio subsystem having an audio input 342 (e.g., a microphone) and an audio output (e.g., a speaker or headset interface). Device 300 further includes in some embodiments, but not necessarily all, a video subsystem 350 including a video input (e.g., digital camera) and a video output (e.g., LCD screen display module).

Additionally, device 300 being a mobile communication device is equipped with a communication subsystem 360 that includes an air interface 362 for communication between the device 300 and other wireless communication systems.

As mentioned above, in some embodiments, the processing subsystem 310 may include one or more processors 312-316 of various kinds. In some embodiments, processing of various kinds can take place within one processor having a processor core. In other examples, the processing can be divided among more than one processor. In a specific example, as depicted, a first processor 312 may be a communications processor adapted for communications functions through the air interface 362. A second processor 314 is dedicated to other types of processing such as applications processing and may be referred to as an applications processor. The applications processor 314 may be coupled to one or more of the other components of system 300, including the U/I 330 or the audio or video subsystems 340, 350. The applications processor 314 may be suited for processing instructions to carry out voice recognition and other functions. In addition, the processing subsystem 310 may include a special-purpose processing element such as a digital signal processor (DSP 316) for accelerating special operations such as may be employed in automatic speech recognition functions. All together, system 300 is adapted on its own or in conjunction with other systems mentioned and known to those skilled in the art to accomplish the functions and methods of the present disclosure.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications.

What is claimed is:

1. A method for training an automatic speech recognition system, comprising:
providing at least an audible prompt to a user of a mobile device;
receiving at least an audible response utterance from said user;
including information from said received utterance in a data collection; and
using said data collection including said information from said received utterance in a system to perform automatic speech recognition of future utterances by said user or other users.

2. The method of claim 1, said providing step including providing a pre-recorded audible prompt to said user of said mobile device through an audio output of said mobile device.

3. The method of claim 1, said providing step including providing a machine-synthesized audible prompt to said user of said mobile device through an audio output of said mobile device.

4. The method of claim 1, further comprising providing a visual prompt to said user on a visual output of said mobile device.

5. The method of claim 1, further comprising receiving a visual response from said user in response to said at least an audible prompt, and including information from said received visual response in a data collection, and using said data collection including said information from said visual response to perform automatic speech recognition of future utterances by said user or other users.

6. A system for automatic speech recognition, comprising:
a mobile communication device having a processor and media for processing information in said mobile device;
said processor and media having machine-readable instructions coded into said mobile device and executable on said processor of said mobile device to cause said mobile device to provide at least an audible prompt to a user of said mobile device;
said processor and media having machine-readable instructions coded into said mobile device and executable on said processor of said mobile device to cause said mobile device to receive at least an audible response from a user of said mobile device;
said processor and media having machine-readable instructions coded into said mobile device and executable on said processor of said mobile device to cause said mobile device to covert said received response into a format suitable for use in a speech recognition training database;
said processor and media having machine-readable instructions coded into said mobile device and executable on said processor of said mobile device to cause said mobile device to communicate said recorded response to a computing device coupled to said mobile device over a network; and
said processor and media having machine-readable instructions coded into said mobile device and executable on said processor of said mobile device to cause said mobile device to carry out automatic speech recognition of future utterances by a user or said mobile device or other users.

7. The system of claim 6, further comprising a wireless communication module for carrying out wireless communications between said mobile device and other devices over a wireless network.

8. The system of claim 6, said mobile device comprising a cellular telephone apparatus.

9. The system of claim 6, further comprising an optical camera apparatus for capturing visual information relating to a condition of a user's face, mouth, lips, or other body parts indicative of the user's response to the at least audible prompt by the system.

10. The system of claim 6, further comprising an audio output module for making an audible prompt audible to a user of said system.

11. The system of claim 6, further comprising a display screen for displaying a message or image to a user of said system relating to an automatic speech recognition function of said system.

12. The system of claim 6, comprising an application processor for processing said machine-readable instructions to enable an automatic speech recognition function of said system and further comprising a communication processor for processing said machine-readable instructions to enable communication between the mobile device and other devices over a wireless network.

13. The system of claim 6, further comprising a coupled database, which includes information collected from a user of said system so as to train and enhance an automatic speech recognition function of said system.
